(19) United States
(12) Patent Application Publication
(10) Pub. No.: US 2008/0058136 A1
(43) Pub. Date: Mar. 6, 2008

(54) Bicycle derailleur

(75) Inventors: Hirokazu Muramoto, Sakai (JP); Satoshi Shahana, Sakai (JP)

Correspondence Address: GLOBAL IP COUNSELORS, LLP, 1233 20TH STREET, NW, SUITE 700, WASHINGTON, DC, 20036-2680, US

(73) Assignee: Shimano Inc., Sakai (JP)

(21) Appl. No.: 11/513,346

(22) Filed: Aug. 31, 2006

(51) Int. Cl. F16H 59/00; F16H 63/00; B62M 9/12

(52) U.S. Cl. 474/82

(57) ABSTRACT

A bicycle derailleur includes a derailleur body, a pivot axle and a chain guide. The pivot axle has a retaining end pivotally retained to the derailleur body and a chain guide supporting end. The chain guide includes a first plate, a second plate and a guide pulley. The first plate is fixedly mounted on the pivot axle to rotate therewith. The second plate is mounted on the pivot axle at location farther from the derailleur body than the first plate. The guide pulley is rotatably mounted on the pivot axle between the first and second plates.

### BACKGROUND OF THE INVENTION

1. Field of the Invention

This invention generally relates to bicycle rear derailleur. More specifically, the present invention relates to bicycle rear derailleur with chain guide assembly that is fixed to a pivot shaft.

2. Background Information

Bicycling is becoming an increasingly more popular form of recreation as well as a means of transportation. Moreover, bicycling has become a very popular competitive sport for both amateurs and professionals. Whether the bicycle is used for recreation, transportation or competition, the bicycle industry is constantly improving the various components of the bicycle. One component that has been extensively redesigned is the bicycle rear derailleur. One area of engineering concern is the overall weight of each and every component of a bicycle, including the bicycle rear derailleur.

The bicycle rear derailleur includes many moving parts that must be made of strong, rigid materials, such as steel. More and more components of the rear derailleur are also being made of lighter materials, such as plastic and composite materials. However, it is difficult to replace some elements of the rear derailleur with such lightweight materials. An alternative is to somehow reduce the number of parts within the rear derailleur.

In view of the above, it will be apparent to those skilled in the art from this disclosure that there exists a need for an improved rear derailleur that has a reduced number of parts. This invention addresses this need in the art as well as other needs, which will become apparent to those skilled in the art from this disclosure.

### SUMMARY OF THE INVENTION

One object of the present invention is to eliminate unnecessary weight from a rear derailleur.

Another object of the present invention is to provide simple design and construction of a rear derailleur.

In accordance with one aspect of the present invention, a bicycle derailleur includes a derailleur body, a pivot axle and a chain guide. The pivot axle has a retaining end pivotally retained to the derailleur body and a chain guide supporting end. The chain guide includes a first plate, a second plate and a guide pulley. The first plate is fixedly mounted on the pivot axle to rotate therewith. The second plate is mounted on the pivot axle at location farther from the derailleur body than the first plate. The guide pulley is rotatably mounted on the pivot axle between the first and second plates.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a side elevational view of a bicycle that includes a rear derailleur in accordance with the present invention;

FIG. 2 is a perspective view of a rear portion of the bicycle showing the rear derailleur in accordance with a first embodiment of the present invention;

FIG. 3 is a cross-sectional view of a portion of the rear derailleur showing details of a movable member, a pivot shaft and a chain guide assembly in accordance with the first embodiment of the present invention;

FIG. 4 is a cross-sectional view of the movable member taken along the lines 4-4 in FIG. 3 in accordance with the first embodiment of the present invention;

FIG. 5 is an exploded perspective view of a portion of the rear derailleur showing the movable member, the pivot shaft and a portion of the chain guide assembly in accordance with the first embodiment of the present invention;

FIG. 6 is a cross-sectional view similar to FIG. 3 showing a pivot shaft and a chain guide assembly removed from the movable member of the rear derailleur in accordance with a second embodiment of the present invention;

FIG. 7 is a cross-sectional view similar to FIG. 6 showing a pivot shaft and a chain guide assembly removed from the movable member of the rear derailleur in accordance with a third embodiment of the present invention;

FIG. 8 is a cross-sectional view similar to FIGS. 6 and 8 showing a pivot shaft and a chain guide assembly shown removed from the movable member of the rear derailleur in accordance with a fourth embodiment of the present invention; and

FIG. 9 is perspective view of the pivot shaft shown removed from the movable member of the rear derailleur in accordance with the fourth embodiment of the present invention.

### DETAILED DESCRIPTION OF THE PREFERRED EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

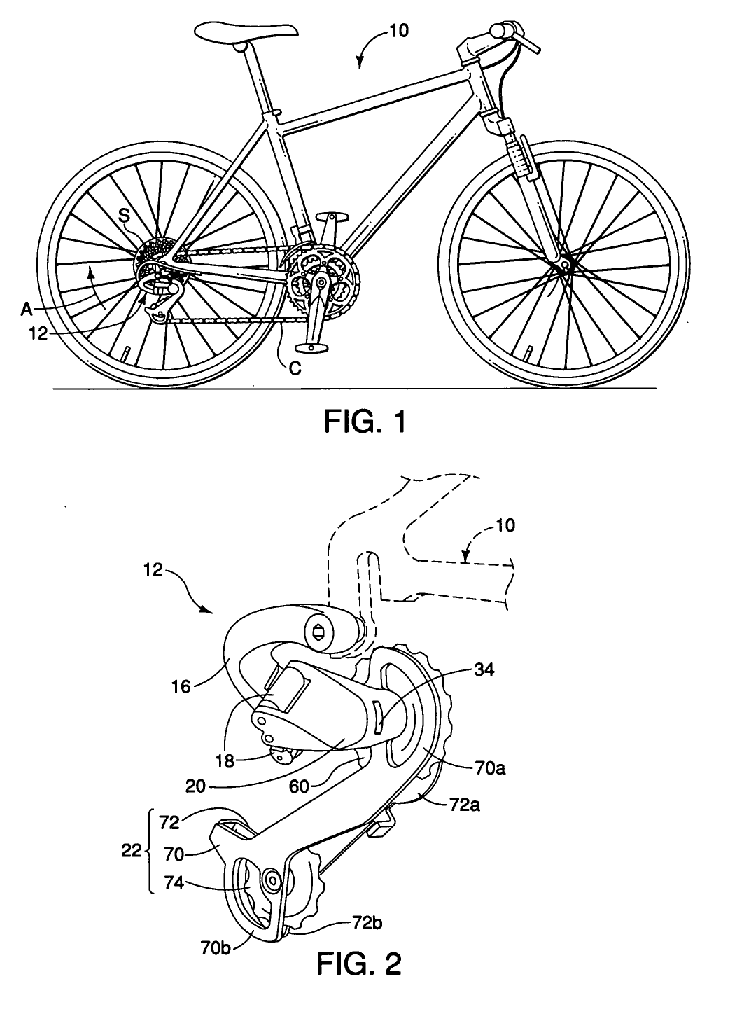

Referring initially to FIGS. 1 and 2, a bicycle 10 that includes a rear derailleur 12 is illustrated in accordance with a first embodiment of the present invention. As shown in FIG. 2, the rear derailleur 12 has a derailleur body that basically includes a base member 16, a linkage assembly 18, a movable member 20 and a chain guide assembly 22.

The base member 16 is configured to be coupled, fixed or otherwise fastened to a rear frame portion of the bicycle 10, as shown in FIG. 2. The linkage assembly 18 includes a plurality of conventional linkage members that are pivotally connected to both the base member 16 and the movable member 20 allowing selective movement of the movable member 20 relative to the base member 16 and the bicycle 10. Movement of the movable member 20 cause a chain C to move between gear sprockets of a rear gear sprocket set S (FIG. 1) in a conventional manner.

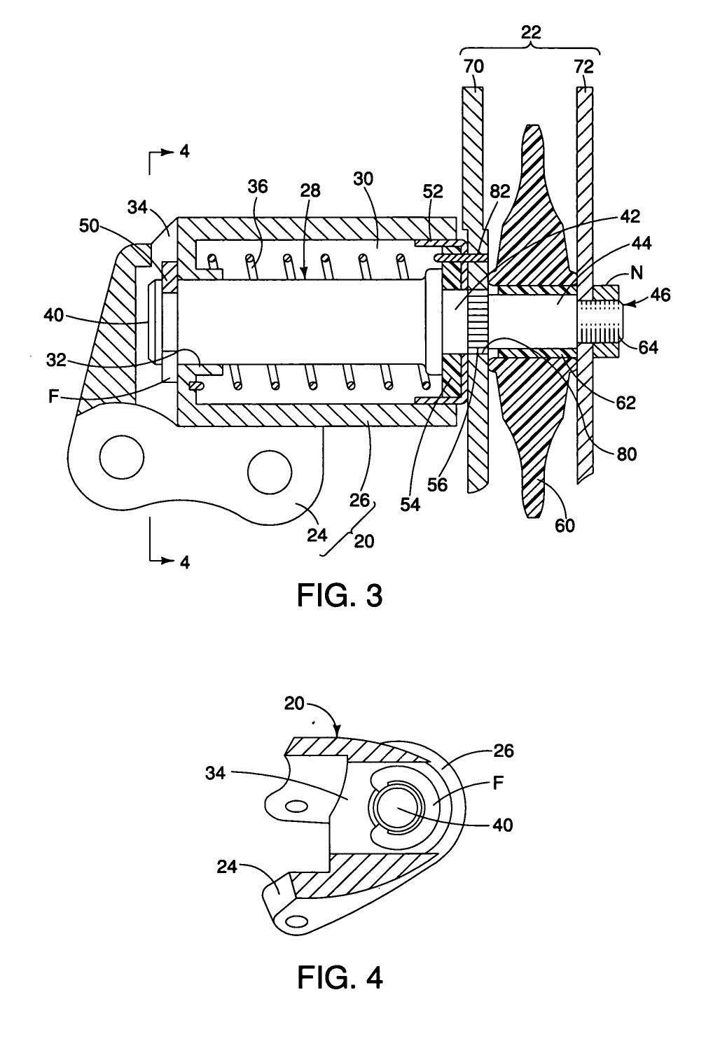

As shown in FIG. 3, the movable member 20 basically includes a linkage connecting portion 24 (two connecting portions 24 are shown in FIG. 4) and a main body 26 that supports a pivot axle 28. The linkage connecting portion 24 includes a plurality of apertures for pivotal connection to the linkage assembly 18 in a conventional manner. The main body 26 of the movable member 20 includes a hollow interior 30, an axle receiving bore 32 and a fastener access through hole 34.

The hollow interior 30 is configured to retain and restrict axial movement the pivot axle 28. Specifically, a portion of the pivot axle 28 extends through the axle receiving bore 32 and is retained by a fastener F. As shown in FIG. 4, the fastener F is a C-clip that slips onto the pivot axle 28 as described in greater detail below.

The hollow interior 30 of the movable member 20 preferably has a cylindrical shape that houses and at least partially conceals a biasing spring 36. The biasing spring 36 is preferably a coil spring that extends around a portion of the pivot axle 28 within the hollow interior 30 of the movable member 20. The pivot axle 28 is preferably co-axially aligned within the hollow interior 30 of the movable member 20.

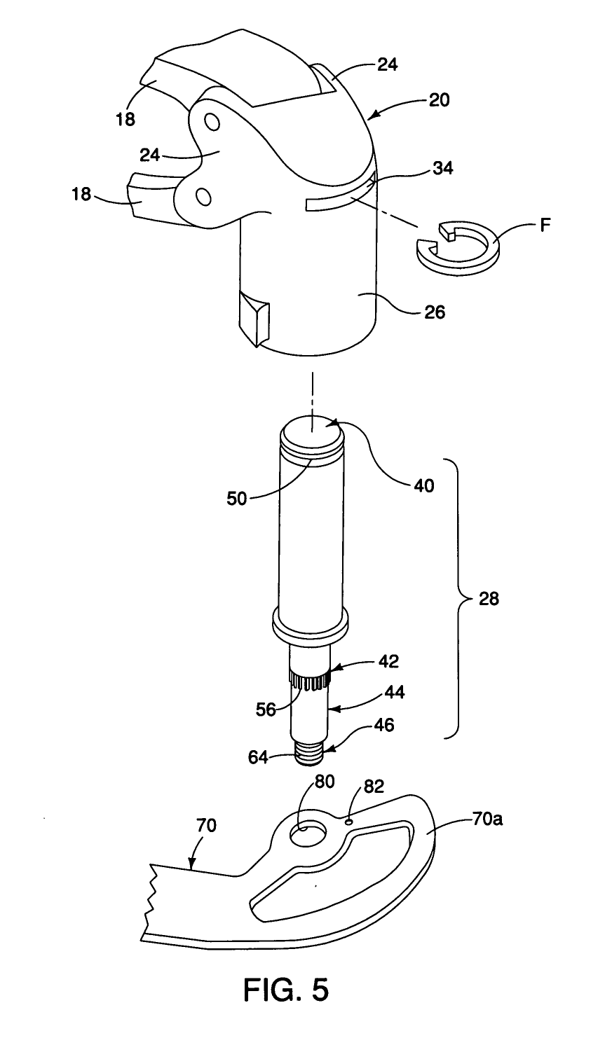

With specific reference to FIG. 5, a description of the pivot axle 28 is now provided. The pivot axle 28 basically includes a retaining end 40, a first chain guide support portion 42, a chain guide pulley support portion 44 and a second chain guide support portion 46. The first chain guide support portion 42, the chain guide pulley support portion 44 and the second chain guide support portion 46 define a chain guide supporting end of the pivot axle 28.

As shown in FIG. 3, the retaining end 40 extends into the axle receiving bore 32 of the movable member 20 and includes an annular recess 50. The fastener F snap fits into the annular recess 50 via the fastener access through hole 34 for retaining the pivot axle 28 within the movable member 20 but allowing pivotal movement of the pivot axle 28 relative to the movable member 20. Hence, the retaining end 40 of the pivot axle 28 is pivotally retained within the movable member 20. A retaining plate 52 and a bushing 54 also support the pivot axle 28 for pivotal movement within the hollow interior 30 of the movable member 20.

The first chain guide support portion 42, the chain guide pulley support portion 44 and the second chain guide support portion 46 of the pivot axle 28 extend out from the hollow interior 30 of the movable member 20 and the retaining plate 52. Whereas, the remaining portions of the pivot axle 28, including the retaining end 40, are concealed within the hollow interior 30 of the main body 26 of the movable member 20.

As shown in FIG. 5, the first chain guide support portion 42 is formed with a plurality of radially outwardly extending serrations or protrusions 56 that preferably have a relatively sharp outer edge. As shown in FIG. 3, the chain guide pulley support portion 44 is a shaft portion that is configured to receive a chain guide pulley 60. The chain guide pulley 60 is disposed on a bushing/bearing 62 for rotational movement about the chain guide pulley support portion 44 of the pivot axle 28. The second chain guide support portion 46 includes machine threads 64, as shown in FIGS. 3 and 5.

The chain guide assembly 22 is supported on the pivot axle 28 for pivotal movement relative to the movable member 20 in a manner described further below. Movement of the movable member 20 relative to the frame of the bicycle 10 causes the chain guide assembly 22 to guide the chain C for movement or shifting between the gear sprockets of the rear gear sprocket set S.

As shown in FIG. 2, the chain guide assembly 22 includes a first plate 70, a second plate 72, a tensioning pulley 74 and the chain guide pulley 60. The first plate 70 has a first end 70a and a second end 70b. The second plate 72 has a first end 72a and a second end 72b.

As shown in FIGS. 3 and 5, the first end 70a of the first plate 70 includes a first aperture 80 and a second aperture 82. The first aperture 80 has an inner diameter that is about the same or slightly larger than the outer diameter of the chain guide pulley support portion 44 of the pivot axle 28. However, the inner diameter of the first aperture 80 is smaller than the outer diameter of the protrusions 56 formed on the first chain guide support portion 42 of the pivot axle 28.

During assembly, the first plate 70 is press-fitted onto the first chain guide support portion 42 of the pivot axle 28 with the pivot axle 28 inserted into the first aperture 80. As the first aperture 80 of the first plate 70 is forced around the protrusions 56 of the first chain guide support portion 42 of the pivot axle 28 during the press fitting process, the protrusions 56 can gouge, deform or otherwise dig into the surface of the aperture 80 the first plate 70 creating a generally permanent engagement therebetween. Consequently, the surface of the aperture 80 of the first plate 70 is fixed to the pivot axle 28 for rotation or pivotal movement therewith.

The second aperture 82 in the first plate 70 receives one end of the biasing spring 36, as shown in FIG. 3. The biasing spring 36 biases the first plate 70 (and the second plate 72) of the chain guide assembly 22 in a chain tensioning direction indicated by the Arrow A in FIG. 1.

As shown in FIG. 3, the first end 72a of the second plate 72 is fixed to the second chain guide support portion 46 by a threaded fastener N that is threaded onto the machine threads 64. Hence, the second plate 72 attaches to the chain guide supporting end of the pivot axle 28. Further, the second plate 72 is mounted on the pivot axle 28 at location farther from the movable member 20 (and the remainder of the derailleur body) than the first plate 70. The first plate 70 is also referred to as an outer plate (relative to the bicycle 10) and the second plate 72 is also referred to as an inner plate (relative to the bicycle 10).

The tensioning pulley 74 is rotatably mounted on an axle between the second ends 70b and 72b of the first and second plates 70 and 72 on a shaft (not shown) spaced apart from the chain guide pulley 60.

### Second Embodiment

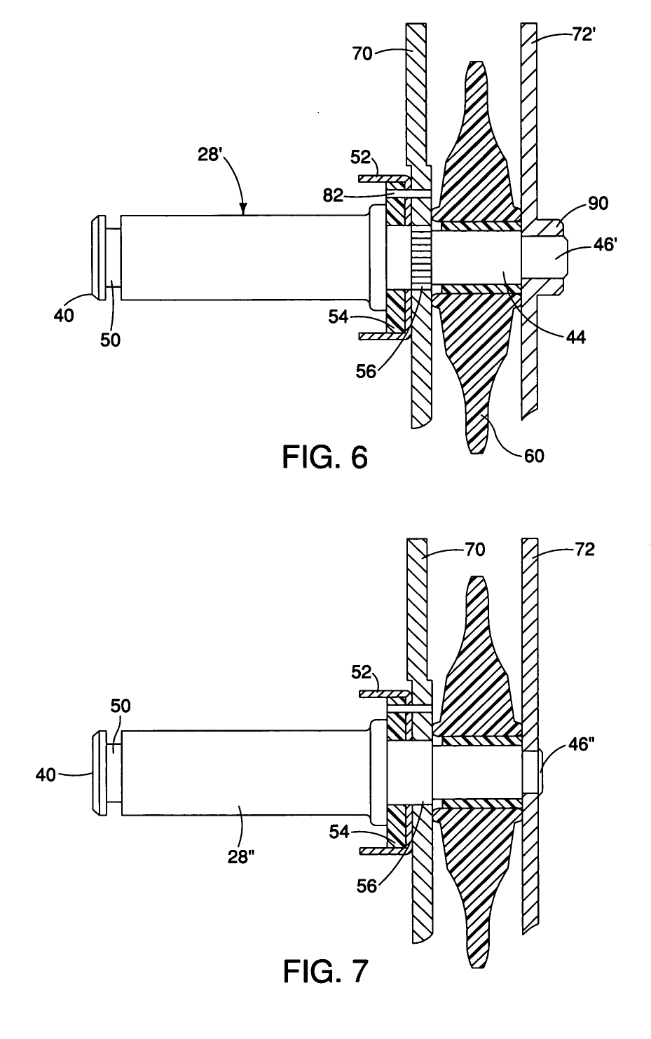

Referring now to FIG. 6, a pivot axle 28′ and a second plate 72′ in accordance with a second embodiment of the present invention will now be explained. In view of the similarity between the first and second embodiments, the parts of the second embodiment that are identical to the parts of the first embodiment will be given the same reference numerals as the parts of the first embodiment. Moreover, the descriptions of the parts of the second embodiment that are identical to the parts of the first embodiment may be omitted for the sake of brevity. The parts of the second embodiment that differ from the parts of the first embodiment will be indicated with a single prime (′).

In the second embodiment, the pivot axle 28′ and a second plate 72′ replace the pivot axle 28 and the second plate 72 in the rear derailleur 12 of the first embodiment. All other elements of the rear derailleur 12 are the same as the first embodiment. In the second embodiment, a second chain guide support portion 46′ of the pivot axle 28′ is a shaft portion with no machine threads. The second plate 72′ includes an annular protrusion 90. The annular protrusion 90 is crimped into engagement with the second chain guide support portion 46′ of the pivot axle 28′ in order to secure the second plate 72′ to the pivot axle 28′.

Alternatively, the second chain guide support portion 46′ of the pivot axle 28′ can be formed with serrations or protrusions (not shown) similar to the protrusions 56 on the first chain guide portion 42. In this configuration the second plate 72′ is press-fitted to the pivot axle 28′.

### Third Embodiment

Referring now to FIG. 7, a pivot axle 28″ in accordance with a third embodiment of the present invention will now be explained. In view of the similarity between the first and third embodiments, the parts of the third embodiment that are identical to the parts of the first embodiment will be given the same reference numerals as the parts of the first embodiment. Moreover, the descriptions of the parts of the third embodiment that are identical to the parts of the first embodiment may be omitted for the sake of brevity. The parts of the third embodiment that differ from the parts of the first embodiment will be indicated with a double prime (″).

In the third embodiment, the pivot axle 28″ replaces the pivot axle 28 in the rear derailleur 12 of the first embodiment. Otherwise, the various elements of the rear derailleur 12 of the first embodiment are the same in the third embodiment. For the sake of brevity, a second chain guide support portion 46″ of the pivot axle 28″ is a shaft portion with no machine threads. The second plate 72 is secured to the pivot axle 28″ by crimping or deforming the end of the second chain guide support portion 46″ of the pivot axle 28″ in order to confine the second plate 72.

### Fourth Embodiment

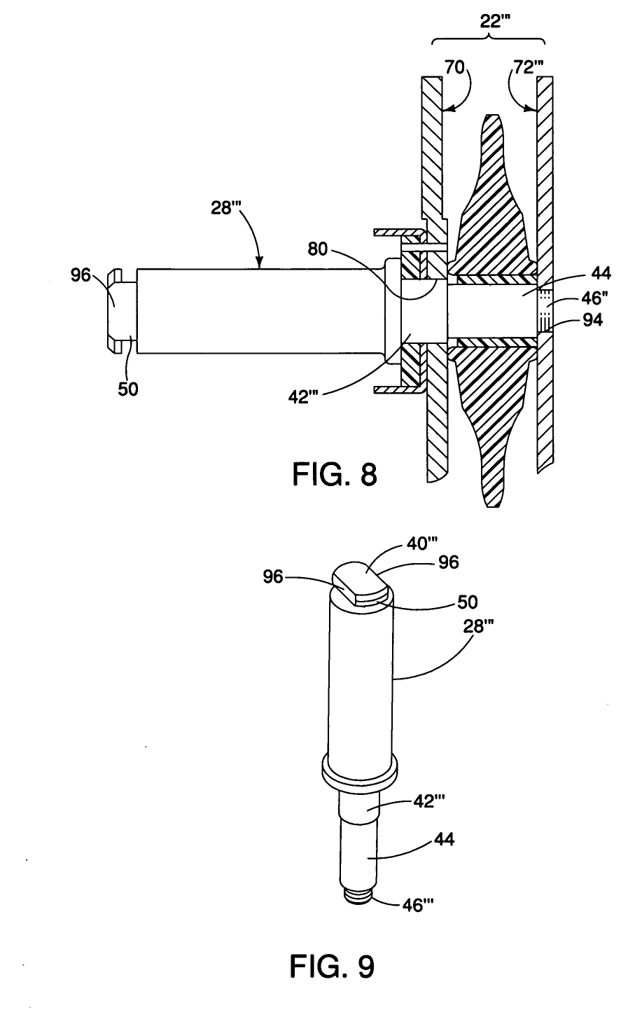

Referring now to FIGS. 8 and 9, a chain guide assembly 22′″ and a pivot axle 28′″ in accordance with a fourth embodiment of the present invention will now be explained. In view of the similarity between the first and fourth embodiments, the parts of the fourth embodiment that are identical to the parts of the first embodiment will be given the same reference numerals as the parts of the first embodiment. Moreover, the descriptions of the parts of the fourth embodiment that are identical to the parts of the first embodiment may be omitted for the sake of brevity. The parts of the fourth embodiment that differ from the parts of the first embodiment will be indicated with a triple prime (′″).

In the fourth embodiment, the chain guide assembly 22′″ and the pivot axle 28′″ replace the chain guide assembly 22 and the pivot axle 28 in the rear derailleur 12 in the first embodiment. Otherwise, the various elements of the rear derailleur 12 in the first embodiment are the same in the third embodiment. The pivot axle 28′″ and the chain guide assembly 22′″ are modified when compared to the pivot axle 28 and the chain guide assembly 22 of the first embodiment. First, a second plate 72′″ of the chain guide assembly 22′″ includes an aperture 94 that includes machine threads. Second, a retaining end 40′″ of the pivot axle 28′″ includes the annular recess 50 but also includes two parallel tool receiving surfaces 96. Further, a first chain guide support portion 42′″ of the pivot axle 28′″ is a generally smooth shaft portion that does not include protrusions such as the protrusions 56 of the first embodiment. As well, a second chain guide support portion 46′″ of the pivot axle 28′″ is shorter than the second chain guide support portion 46 of the first embodiment and includes machine threads.

When the chain guide assembly 22′″ is assembled to the pivot axle 28′″, the first plate 70 is fitted on the first chain guide support portion 42′″ of the pivot axle 28′″ without necessarily being press-fitted since there are no protrusions on the pivot axle 28′″. The chain guide pulley 60 is installed on the chain guide pulley support portion 44 next. Finally, the second chain guide support portion 46′″ of the pivot axle 28′″ is inserted into the threaded aperture 94 of the second plate 72′″ of the chain guide assembly 22′″. By engaging a tool such as a wrench (not shown) with the tool receiving surfaces 96 on the pivot axle 28′″, the machine threads on the second chain guide support portion 46′″ of the pivot shaft 28′″ can be threaded into the threaded aperture 94 of the second plate 72′″ and tightened thereto. Hence, the second plate 72′″ is fixedly mounted on the pivot axle 28′″ so that the second plate 72′″ rotates with the pivot axle 28′″.

In the fourth embodiment, the first plate 70 (the outer plate) and the chain guide pulley 60 are disposed or sandwiched between the movable member 20 and the second plate 72′″ (the inner tension plate).

### General Interpretation of Terms

The foregoing also applies to words having similar meanings such as the terms, “including”, “having” and their derivatives. Also, the terms “part,” “section,” “portion,” “member” or “element” when used in the singular can have the dual meaning of a single part or a plurality of parts. As used herein to describe the present invention, the following directional terms “forward, rearward, above, downward, vertical, horizontal, below and transverse” as well as any other similar directional terms refer to those directions of a bicycle equipped with the present invention. Accordingly, these terms, as utilized to describe the present invention should be interpreted relative to a bicycle equipped with the present invention as used in the normal riding position. Finally, terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A bicycle derailleur comprising:
a derailleur body;
a pivot axle having a retaining end pivotally retained to the derailleur body and a chain guide supporting end;
a chain guide including a first plate fixedly mounted on the pivot axle to rotate therewith, a second plate mounted on the pivot axle at location farther from the derailleur body than the first plate, a guide pulley rotatably mounted on the pivot axle between the first and second plates.

2. The bicycle derailleur as set forth in claim 1, wherein,
the derailleur body includes a base member configured to be coupled to a bicycle, a linkage assembly coupled to the base member and a movable member movably coupled to the linkage assembly, the pivot axle is pivotally retained to the movable member.

3. The bicycle derailleur as set forth in claim 2, wherein
the second plate is coupled to the pivot axle by a fastener member that attaches to the chain guide supporting end.

4. The bicycle derailleur as set forth in claim 2, wherein
the second plate is coupled to the pivot axle by crimping a portion of the second plate about the pivot axle or by crimping the pivot axle.

5. The bicycle derailleur as set forth in claim 2, wherein
the movable member includes a hollow interior configured to retain and restrict axial movement of the retaining end of the pivot axle.

6. The bicycle derailleur as set forth in claim 1, wherein
the first plate is fixed to the pivot axle by press fitting.

7. A bicycle derailleur comprising:
a derailleur body including a movable member;
a pivot axle including a retaining end pivotally retained within the movable member and a chain guide supporting end;
a torsion spring disposed within the movable member and around the pivot axle;
a chain guide including a first plate mounted on the pivot axle, a second plate fixedly mounted on the pivot axle at location farther from the movable member than the first plate so that the second plate rotates with the pivot axle, a guide pulley rotatably mounted on the pivot axle between the first and second plates.

8. The bicycle derailleur as set forth in claim 7, wherein
the second plate includes a threaded bore that is threaded to threads formed on the chain guide supporting end of the pivot axle.

9. The bicycle derailleur as set forth in claim 8, wherein
the movable member includes a hollow interior configured to retain and restrict axial movement of the retaining end of the pivot axle.

10. The bicycle derailleur as set forth in claim 9, wherein
the movable member includes an axle receiving bore co-axially aligned within the hollow interior of the movable member.

11. The bicycle derailleur as set forth in claim 7, wherein
the retaining end of the pivot axle includes a tool receiving portion.

12. The bicycle derailleur as set forth in claim 7, wherein
the derailleur body further includes a base member configured to be coupled to a bicycle and a linkage assembly coupled to the base member and the movable member.

13. The bicycle derailleur as set forth in claim 7, wherein
the movable member includes a hollow interior configured to retain and restrict axial movement of the retaining end of the pivot axle.

14. The bicycle derailleur as set forth in claim 7, wherein
the torsion spring biases the chain guide in a chain tensioning direction.
